(19) United States
(12) Patent Application Publication
(10) Pub. No.: US 2009/0091931 A1
(43) Pub. Date: Apr. 9, 2009

(54) Illumination device with side aimed light source and two step light dispersion

(76) Inventor: Eric O. Eriksson, Glenview, IL (US)

Correspondence Address: ERIC ERIKSSON, 3816 LIZETTE LN, GLENVIEW, IL, 60026, US

(21) Appl. No.: 12/284,907

(22) Filed: Sep. 26, 2008

Related U.S. Application Data
(60) Provisional application No. 60/995,950, filed on Sep. 28, 2007.

(51) Int. Cl. F21V 8/00

(52) U.S. Cl. 362/235

(57) ABSTRACT

A two step process of light manipulation to obtain an even toned linear light from point sources of light. This process obtained by taking evenly space particular point sources of light (element A) delivering essentially 100% of their light into the side of an adjacent clear rod (element B). The light turns 90 degrees and travels down the clear rod (element B) in what is called a “waveguide” effect. Adjacent and parallel to A and 90 degrees turned from B is element C, a diffusing rod like member. A, B and C form a triad with A and C in separate contact with B. A and C oriented more or less 90 degrees to each other with B as the pivot point. The triad of A, B and C are contained in a channel where only C sticks out half way. Light from B illuminates C which finishes evening out the light and delivers the final bright even tone of light beyond the containing channel thru the exposed portion of element C.

### BACKGROUND OF THE INVENTION

The present invention is an illumination device that combines side aiming point sources of light that illuminate a waveguiding clear rod which in turn illuminates a light diffusing waveguide to deliver a neon like bright even tone of linear light in a very compact shape.

The starting point has been to create a bright even tone of light like neon lighting without the downfalls of neon. Neon lighting is made by passing an electric current thru a gas filled glass tube exciting the electrons and creating the neon light effect. It has been around for about 90 years and has had relatively few improvements. Some of its desirable attributes are its long life, even round 360 degree view light tone, even tone as viewed from any angle, the ability to factory bend the glass to create a practically unlimited range of text and images for the signage industry. Some of its negative attributes are the breakability of the glass, its difficulty to ship without breaking, its very high voltage (8,000 to 15,000 volts) that is difficult to safely contain, its tendency to cause building fires, the presence of environmentally unfriendly mercury in the tubes and the higher cost of energy to operate.

The enduring popularity of neon's bright, even round line of light has spawned many attempts to create alternate methods to the same end. Two different families of light emitting devices that might lend themselves to this goal are flat even sources of light such as electroluminescent tape, or a string of point sources of light that have their light evened out before emitting from the fixture. Each has its challenges. A particularly useful lighting device for use in the string of point sources of light approach is the Light Emitting Diode (LED). Some good but incomplete progress has been made in this goal of a bright, even and economically viable linear light it the spirit of neon as shown in U.S. Pat. No. 6,592,238, U.S. Pat. No. 6,834,979, U.S. Pat. No. 7,011,421 B2 and U.S. Pat. No. 7,264,366 B2

The current invention has learned from and these previous efforts and endeavors to branch out into new territory by creating a new smaller profile even toned linear light system. The current invention has succeeded in cutting in half the height of the state of the art profile as defined in the referenced patents and still maintain the even bright linear light effect. This is no small accomplishment. As an option this current invention can include a color conversion of light system. In this system the light emitted from the illumination device to the outside is of a different wavelength of the light emitted from the light source inside the illumination device.

### BRIEF EXPLANATION OF THE DRAWINGS

FIG. 9 shows a section of the illumination device showing the light from the light sources entering the clear waveguide.

FIG. 10 shows the light from the clear waveguide enter the diffusing rod.

FIG. 11 shows the introduction of a color converting element into the system.

FIG. 12 shows the triad nature of the illumination device.

### DETAILED DESCRIPTION OF THE INVENTION

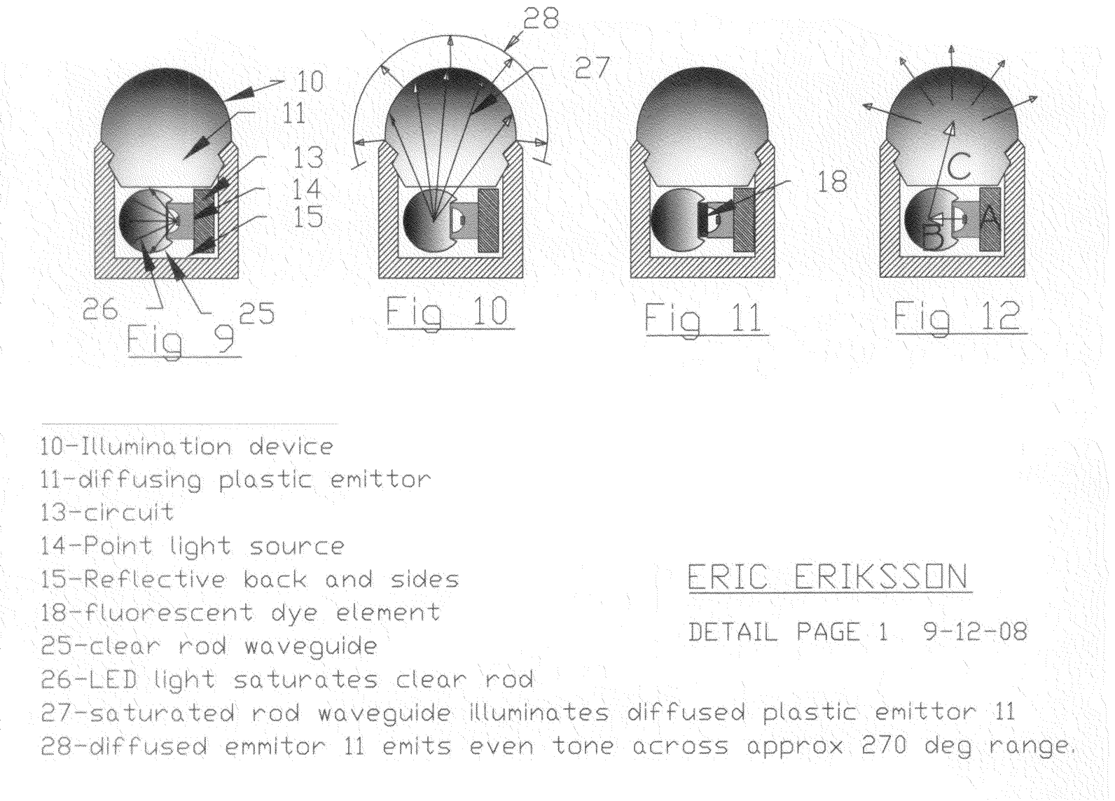

FIGS. 9 thru 11 show sectional views of exemplary illumination devices 10 made in accordance with the present invention reflecting a two step light manipulation process to attain even toned linear light from point sources of light. First light is emitted form a particularly shaped light source, one that is small in size and that directs all its light as a spread in one direction. In the current drawings we are showing a surface mounted Light Emitting Diode (LED) 14 that has the emitting chip imbedded in a cube shaped opaque ceramic cup that directs all the light out in an approximate 120 degree field off of one face of the six sided cube. No light goes backward or sideways. The LEDs are mounted at regular intervals on an electrical circuit 13 that maintains their positions in an organized linear fashion. The mounted LEDs are then pressed against a clear more or less round rod 25 that has been cut or extruded flat on one side so that there is essentially 100% contact between the LEDs and the rod. To be precise, the lit face of the LEDs is pressed against the flattened face of the essentially round rod. This is important because we want essentially 100% of the light 26 from the LEDs to enter the rod 25. If light were to leak out to the sides it would diminish the effectiveness of the invention in that it would increase the likelihood of visible hot spots of light on the final emitting surface of the device. As a side note it is possible to add flanges to the edges of the flattened side of the rod to assure a proper line up of the LEDs to the rod.

We have established that essentially 100% of the light 26 from the LED has now entered the clear rod. Due to the nature of how light acts when it enters such structures a good portion of the light will stay in the rod and travel horizontally in what is described as waveguiding. Of course some of the light passes thru the rod to the reflective surface 15 of the containment channel wall behind the rod. Some of that light bounces back into the waveguiding rod. This effect adds a measurable amount of light to the whole system. This bounce back effect also adds an additional lateral light diffusing effect to enhance the goal of even light. The intensity of light contained in the rod is very evident in lab experiments. If one were to look down into the channel with the diffusing rod 11 removed one would see a very bright waveguiding clear rod. One would also clearly see the light from each LED 26 in the clear rod waveguide as it enters the clear rod. In essence one sees primarily waveguided light not diffused light. This is the first step. The second step is to place a diffusing rod like element 11 adjacent to and above the clear rod 25. It is best if the clear rod and diffusing rod are in contact. The light in the clear rod 27 makes its way into the diffusing rod like member 11 in a fairly evenly distributed fashion and then the diffusing rod finishes the evening out job finally delivering a final even tone of linear light 28 in a very compact shape with a height to width ratio of approximately 1.6/1.

FIG. 12—to review: Evenly space particular point sources of light (element A) deliver essentially 100% of their light into the side of an adjacent clear rod (element B). The light turns 90 degrees and travels down the clear rod (element B) in what is called a “waveguide” effect. Adjacent and parallel to A and 90 degrees turned from B is element C, a diffusing rod like member. A, B and C form a triad with A and C in separate contact with B. A and C oriented 90 degrees to each other with B as the pivot point. The triad of A, B and C are contained in a reflective channel where only C sticks out half way. Light from B illuminates C which finishes evening out the light and delivers the final visible bright even tone of light beyond the containing channel.

Some of the materials one may use to assemble this illumination device are as follows:
The clear rod like optical waveguide can be clear acrylic rod of varying diameters, perhaps 3/16″ dia. This material is commonly available in most hobby stores. No specific mfgr is preferred.
The diffusing rod material can be obtained from AtoUaas, Philadelphia, Pa. with the product frosted #DR66080.
An appropriate surface mounted light emitting diode could be a #LM1-AHR1-01-N1 EP RED obtained from Marktech Optoelectronics in Latham, N.Y.

### SUMMARY

In summary we have a close packed triad of three unique elements, housed in a channel, that have very different forms and functions. When these clearly defined forms and functions are combined in the proper way they deliver a clean bright even tone of linear light from a very small package. Remove any part of the triad and the system fails to deliver. Put them in a different physical orientation and they fail to deliver. Put their functions in a different order and they fail to deliver. Thus the uniqueness and non-obviousness of the idea. A plurality of point sources of light illuminating a clear optical waveguide which in turn illuminates a optically diffusing waveguide delivering an even tone of light in a very compact package.

An additional feature is available in the system that is the addition of a fluorescent dye membrane to allow color conversion. How this would work is that a fluorescent dyed membrane (item 18 in FIG. 11) would be placed between the LEDs 14 and the clear rod 25. The light of a particular hue or wavelength from the LEDs passes thru the fluorescent membrane on its way to the rod. As it passes thru the membrane the fluorescent dyes change a portion if the light to a lower energy level or different wavelength. The result is that the light that exits the system has a different hue or color than that of the light source. In this way a large number of different colors can be achieved with one color of LED and the proper mix of one or more fluorescent dyes. A very useful mix attains a variety of shades of white light from warm to cool from a string of blue LEDs and an orange fluorescent dye. with the light from the light sources in its first step essentially all enters the substantially clear rod, waveguides along the length of the rod then in its second step the light exits out into the diffusing rod which in turn emits a;

What is claimed is:

1. An illumination device for simulating neon lighting, comprising:
a series of light sources spaced evenly in a linear fashion;
a substantially clear optical waveguide of a predetermined length adjacent to the light sources with the light sources aiming more or less directly into the rod, the vast majority of light entering the substantially clear optical waveguide in the first step of the process;
a light diffusing member of a predetermined length, with light receiving and light emitting surfaces where the light receiving surface is adjacent to the waveguide and is oriented approximately 90 degrees to the linear oriented light sources, said diffusing member receiving its light from the waveguide as the second step in the process;
these three elements forming a triad where the light sources, waveguide and the back portion of the diffusing member are contained as said triad in an open faced channel with the light emitting surface of the diffusing member protruding from the channel which ultimately emits an essentially even neon like tone of light along the longitudinal axis of the illumination device.

2. The illumination device in claim 1, wherein a fluorescent dyed member is added between the light sources and the substantially clear waveguide member, this fluorescent dyed member converting a portion of the light from the light source to a different wavelength to the effect that the hue of light that emits from the emitting surface of the illumination device is different from that that emits from the light source.

3. The illumination device in claim 1, where the light source is plurality of light emitting diodes.

4. The illumination device in claim 1, where the open faced channel has opaque walls.

5. The illumination device in claim 1, where the open faced channel has inside surfaces that are reflective.

6. The illumination device in claim 1, where the open faced channel has outside surfaces that are opaque.

7. The illumination device in claim 2, where the light source is plurality of light emitting diodes.

8. The illumination device in claim 2, where the open faced channel has opaque walls.

9. The illumination device in claim 2, where the open faced channel has inside surfaces that are reflective.

10. The illumination device in claim 2, where the open faced channel has outside surfaces that are opaque
